(19) United States
(12) Patent Application Publication
(10) Pub. No.: US 2012/0327999 A1
(43) Pub. Date: Dec. 27, 2012

(54) Encoding mode values representing prediction modes

(75) Inventors: Edouard FRANCOIS, Bourg Des Comptes (FR); GUILLAUME LAROCHE, Melesse (FR); PATRICE ONNO, Rennes (FR)

(73) Assignee: CANON KABUSHIKI KAISHA, Tokyo (JP)

(21) Appl. No.: 13/484,137

(22) Filed: May 30, 2012

Related U.S. Application Data
(60) Provisional application No. 61/505,648, filed on Jul. 8, 2011.

(30) Foreign Application Priority Data
Jun. 2, 2011 (GB) 1109275.6

(51) Int. Cl. H04N 7/32

(52) U.S. Cl. 375/240.02; 375/E07.133

(57) ABSTRACT

A method of encoding a mode value representing a prediction mode comprises selecting from among at least first and second encoding processes an encoding process to apply to the mode value to be encoded. The first encoding process comprises encoding first information indicating a predetermined relationship between the mode value to be encoded and at least one predetermined value. The second encoding process comprises encoding second information representing the mode value to be encoded. The encoding by the second encoding process takes account of the outcome of at least one prior first encoding process. This can be achieved by updating mode probabilities based on the outcome of the first, as well as the second, encoding process. Such a method creates a link between the first and second encoding processes and can improve coding efficiency.

### CROSS-REFERENCE TO RELATED APPLICATIONS

This application claims the benefit under 35 U.S.C. §119(a)-(d) of United Kingdom Patent Application No. 1109275.6, filed on Jun. 2, 2011 and entitled “Encoding mode values representing prediction modes” and also claims the benefit under 35 U.S.C. §119(e) of U.S. Provisional Patent Application No. 61/505,648, filed on Jul. 8, 2011 and also entitled “Encoding mode values representing prediction modes”

Each of the above cited patent applications is incorporated herein by reference in its entirety.

### BACKGROUND OF THE INVENTION

1. Field of the Invention

The invention relates to encoding mode values representing prediction modes. The invention relates more specifically to intra mode coding in the High Efficiency Video Coding (HEVC) standard under development.

2. Description of the Related Art

Video applications are continuously moving towards higher resolution. A large quantity of video material is already distributed in digital form over broadcast channels, digital networks and packaged media, with a continuous evolution towards higher quality and resolution (e.g. higher number of pixels per frame, higher frame rate, higher bit-depth or extended color gamut). This technology evolution brings higher pressure on the distribution networks that are already facing difficulties to carry HDTV resolution and data rates economically to the end user. Therefore, any further data rate increase will put additional pressure on the networks. To handle this challenge, ITU-T and ISO/MPEG decided to launch in January 2010 a new video coding standard project, named High Efficiency Video Coding (HEVC).

The HEVC codec design is similar to that of most previous so-called block-based hybrid transform codecs such as H.263, H.264, MPEG-1, MPEG-2, MPEG-4, SVC. Video compression algorithms such as those standardized by the standardization bodies ITU, ISO and SMPTE use the spatial and temporal redundancies of the images in order to generate data bit streams of reduced size compared with these video sequences. Such compressions make the transmission and/or storage of the video sequences more effective.

During video compression in the proposed HEVC encoder, each block of an image being processed is predicted spatially by an “Intra” predictor (so-called “Intra” coding mode), or temporally by an “Inter” predictor (so-called “Inter” coding mode). Each predictor is a block of pixels issued from the same image or another image, from which a difference block (or “residual”) is derived. In the Intra coding mode the predictor (Intra predictor) used for the current block is a block of pixels constructed from the information already encoded of the current image. Thanks to the identification of the predictor block and the coding of the residual, it is possible to reduce the quantity of information actually to be encoded.

The encoded frames are of two types: temporal predicted frames (either predicted from one reference frame called P-frames or predicted from two reference frames called B-frames) and non-temporal predicted frames (called Intra frames or I-frames). In I-frames, only Intra prediction is considered for coding blocks. In P-frames and B-frames, Intra and Inter prediction are considered for coding blocks.

If “Intra” coding is selected, an item of information for describing the “Intra” predictor used is coded before being inserted in the bit stream to be sent to a corresponding decoder.

In the current HEVC design, as well as in previous designs such as MPEG-4 AVC/H.264, intra coding involves deriving an intra prediction block from reconstructed neighboring samples 101 of the block to be encoded (decoded), as illustrated schematically in FIG. 1A. Multiple prediction modes are supported, either directional or non-directional. In HEVC the number of supported modes depends on the size of a coding unit (CU). As at the filing date of the present application the HEVC specification is still subject to change but presently the following supported modes are contemplated: 3 modes for 64×64 CU, 17 modes for 4×4 CU, 34 modes for CU of other sizes (8×8 to 32×32).

When a CU is intra coded, its related intra prediction mode has to be coded. Referring to FIG. 1B, when coding a current CU 102, Intra mode coding makes use of two neighbouring CUs that have already been coded, namely the Top and Left CUs 103 and 104.

FIG. 2 is a flowchart for use in explaining how Intra mode coding is performed in the current HEVC design. In a first step S201 the Intra mode of the neighboring Top and Left CUs 103 and 104 is identified. The two CUs may share the same Intra mode or may have different Intra modes. Accordingly, in step S201 one or two different modes can be identified. The one or two identified modes are called ‘Most Probable Modes’ (MPMs). In step S202, in the case of two different modes, the MPMs are ordered according to their mode values, the mode having the smaller mode value being referred to as MPM and the mode having the larger mode value being referred to as MPM2. In step S203 the mode of the current coding unit is then compared to the one or two MPMs. If it is equal to the MPM or, if there are two MPMs, to one of them, then in step S204 a first coding process (process 1) is applied.

This first coding process involves coding a flag signaling that the mode of the current block is the MPM, or one of the MPMs, and then, in the case in which there are two MPMs, coding the index of the MPM (0 if first MPM, 1 if second MPM).

If in step S203 the mode of the current block is not equal to the one MPM or to one of the two MPMs, then in step S205 a second coding process (process 2) is applied.

Unlike the first coding process, the second coding process involves coding the mode value of the current block.

Two entropy coding methods are proposed for use in HEVC: syntax-based context-adaptive binary arithmetic coding (SBAC), proposed for use in high coding efficiency configurations, and context-adaptive variable-length coding (CAVLC), proposed for use in low complexity configurations. The first and second intra mode coding processes in S204 and S205 differ depending on these two coding methods, as explained below.

FIG. 3 is a flowchart for use in explaining intra mode coding with SBAC. Steps S301, S302 and S303 are the same as steps S201, S202 and S203, respectively, in FIG. 2 and are not described again here.

In step S303, when the mode is equal to the one MPM, or to one of the two MPMs, process 1 is applied and processing jumps to step S306. First, a bit-value ‘1’ is coded to signal that the mode is a MPM (step S306). In step S307 it is checked if only one MPM is available and, if so, the process terminates. Otherwise, in step S308 an additional flag is coded to indicate the index of the MPM that is equal to the mode.

In step S303, when the mode is not equal to the one MPM or to either of the two MPMs, processing jumps to step S309 and process 2 is applied. First, a bit-value ‘0’ is coded to signal that the mode is not a MPM (step S309). In step S310 it is checked how many MPMs have been identified.

If two MPMs have been identified, the mode is selectively decremented by 1 or 2 in step S311. In particular, if the mode is greater than or equal to MPM (the lower of the two identified MPMs) and greater than or equal to MPM2 (the higher of the two identified MPMs) then the mode is decremented by 2. If the mode is less than MPM2 (the higher of the two identified MPMs) but greater than or equal to MPM (the lower of the two identified MPMs) then the mode is decremented by 1. Otherwise, the mode of the current block is not decremented.

If one MPM has been identified, the mode is selectively decremented by 1 in step S312. In particular, if the mode is greater than or equal to the one MPM, then the mode is decremented by 1. Otherwise, the mode of the current block is not decremented.

In step S313 the resulting mode value is then binarized. In step S314 each bin of the binarized value is finally coded by the SBAC entropy coder.

FIG. 4 is a flowchart for use in explaining intra mode coding with CAVLC. Steps S401, S402 and S403 are the same as steps S201, S202 and S203, respectively, in FIG. 2, and are not described further here.

In CAVLC, two VLC tables are defined, with size N-1 and N-2, where N is the number of possible intra modes. In addition, two index tables are defined, with size N-1 and N-2. These tables serve as ranking tables, related to the probabilities of the modes.

Each index table stores a list of ranks for N-1 or N-2 index values. An example of an N-2 index table 504 for coding a 4×4 CU having 17 modes is shown in FIG. 5. It has entries for index values 0 to 14, each entry storing the rank for the index value concerned. The ranks are adaptively modified, such that a mode value that is coded more frequently will have a smaller rank (close to 0), whereas a mode value that is coded more rarely will have a higher rank.

Each VLC table stores a list of VLC codes for the N-1 or N-2 rank values. An example of an N-2 VLC table 505 for coding a 4×4 CU having 17 modes is shown in FIG. 5. It has entries for index values 0 to 14, each entry storing a VLC code for the index value concerned. The VLC table 505 is ordered based on the VLC code length. VLC code 0 is the shortest one, and VLC code 14 is the longest one. Hence a mode that is frequent will be ranked with a low value, and therefore use a short VLC code, which results in reduced coding cost.

When the mode is equal to one of the MPMs, process 1 is applied and works as follows. First, in step S406 a specific VLC codeword, e.g. VLC 0, is coded to signal that the mode is a MPM. In step S407 it is checked whether one or two MPMs have been identified. If only one MPM has been identified, the process terminates. Otherwise, in step S408 a flag is coded to indicate the index of the MPM that is equal to the mode.

When the mode is not equal to the one MPM or to one of the two MPMs, process 2 is applied and works as follows. A check is made in step S409 of the number of identified MPMs.

If two MPMs have been identified, the mode is selectively decremented by 1 or 2 in step S410. This corresponds to step S311 in FIG. 3. The mode, decremented as necessary in step S410, is used as an index into the relevant index table 504 of size N-2. Then, in step S412 the rank idx_{mode} of the index (i.e the mode decremented as necessary in S410) is obtained from the index table 504 of size N-2. This is illustrated schematically at 501 in FIG. 5. This rank actually reflects the probability of the index value which, as noted above, may differ from the current mode value because of the selective decrementing in S410.

For example, as illustrated in FIG. 5, suppose that the mode value is 14 and that MPM has mode value 2 and MPM2 has mode value 6. In this case, because the mode value is greater than or equal to the mode values of MPM and MPM2, the mode value is decremented by 2 and so the index value becomes 12. Index value 12 has rank 11 and this rank is retrieved from the index table 504.

In step S414 the rank idx_{mode} of the index value is then coded using the VLC table 505 of size N-2, as illustrated schematically at 502 in FIG. 5. Finally, in step S416 the index table 504 of size N-2 is updated by a swapping process, as illustrated schematically at 503 in FIG. 5. In the swapping process the rank immediately preceding the rank of the current index is incremented by 1 and the rank of the current index is decremented by 1. This makes the current index more probable than the index whose rank formerly immediately preceded the rank of the current index.

For example, in FIG. 5, index value 12 has rank 11 and index value 2 has rank 10 immediately preceding the rank of the current index. Thus, in the swapping process, the indices for mode values 12 and 2 are swapped so that, after swapping, index value 12 has rank 10 and index value 2 has rank 11. The resulting index table is denoted by 506 in FIG. 5.

If only one MPM has been identified, then in step S411 the mode is selectively decremented by 1 to obtain an index into the relevant index table of size N-1. This corresponds to step S312 in FIG. 3. Then, in step S413 the rank idx_{mode} of the index is identified in the index table of size N-1. In step S415 the index is coded using the VLC table of size N-1. Finally, in step S417 the index table of size N-1 is updated by swapping the current index and its preceding index, making the current index more probable than its preceding index.

The coding processes described above with reference to FIGS. 3 to 5 suffer from several problems.

Firstly, there is no link between the two coding processes invoked in intra mode coding. In particular, the modes probabilities used in process 2 do not benefit at all from what happens in process 1. This may result in a loss of coding efficiency.

Secondly, in the CAVLC case, 4 index tables are required, 2 for the 4×4 blocks case (one table of 15 elements and one table of 16 elements), 2 for the 8×8 to 32×32 blocks case (one table of 32 elements and one table of 33 elements). These tables do not directly reflect the probability of the modes, because of the index derivation process that decorrelates the mode value from the index. This can also result in a loss of coding efficiency.

Thirdly, in the SBAC case, when process 1 is applied, the order of the modes is fixed (not adaptive) and does not take into account their probability. SBAC encodes the different bins of the binarised index with a single coding engine (also usually named context). Because the binarisation is fixed and applies identically for all the possible values to be coded, the probabilities of bins 0 and 1 are generally rather similar. This affects the arithmetic coding which is more efficient when the bins are unequally distributed. If the binarisation generates a less balanced distribution of bins 0 and 1, this would result in a better efficiency of the arithmetic coding engine (less bitrate).

US 20090110070 proposes an intra coding mode process based on adjacent blocks already coded. Edge information is derived from neighborhood samples and used to estimate the likelihood of the different coding modes. A neural network is used to estimate these likelihoods. Likelihoods are then used to derive the MPM and to dynamically derive an optimal VLC table.

US 20090161974 introduces the concept of swapped index tables as used in CAVLC mode of HEVC.

US 20080013629, US 20040008771 and U.S. Pat. No. 7,289,674 describe an intra mode coding, consisting in splitting the set of possible modes into two sets, the most probable modes ordered according to their probability (estimated on the neighborhood) and the remaining modes ordered according to a predefined order.

In U.S. Pat. No. 7,236,524, coding of the intra prediction mode is performed by selecting first the best intra prediction mode for adjacent blocks, used as preferred modes. It is then used to code the current mode (similarly as done with the Most probable mode concept). If not used, the possible set of modes is reduced. It is the same concept as what is done in H.264 or HEVC.

### SUMMARY OF THE INVENTION

One aspect of the present invention aims to address one or more of the problems in the prior art described above.

Another aspect of the present invention aims to improve the coding efficiency in intra mode coding.

Another aspect of the present invention aims to take account of the outcome of process 1 when carrying out intra mode coding.

Another aspect of the present invention aims for the order of the modes to be adaptive in process 1, so as to take into account the probabilities of the modes.

Another aspect of the present invention aims to reduce the number of tables required to perform intra mode coding.

Another aspect of the present invention aims for tables used for intra mode coding to reflect the probabilities of the modes more directly.

Another aspect of the present invention aims to improve binarisation by taking into mode probabilities.

According to a first aspect of the present invention there is provided a method of encoding a mode value representing a prediction mode. The method comprises selecting from among at least first and second encoding processes an encoding process to apply to the mode value to be encoded, the first encoding process comprising encoding first information indicating a predetermined relationship between the mode value to be encoded and at least one predetermined value, and the second encoding process comprising encoding second information representing the mode value to be encoded. The encoding by the second encoding process takes account of the outcome of at least one prior first encoding process.

Such a method can establish a link between the first and second encoding processes. This can avoid the problem that the second encoding process performs its encoding without knowledge of the outcomes of the prior first encoding processes. This can lead to a mode which is dominant across the picture as a whole, e.g. a background mode, being forgotten when foreground objects are coded.

The predetermined relationship between the mode value to be encoded and at least one predetermined value is not limited but in a preferred embodiment there are 1 or 2 predetermined values and the predetermined relationship exists when the mode value to be encoded is equal to the or one predetermined value.

In a preferred embodiment, the first encoding process is selected when the mode value to be encoded is equal to the or one predetermined value, and the second encoding process is selected when the mode value to be encoded differs from the or each predetermined value.

When the predetermined relationship is the preferred one set out above, then in the case in which the mode value to be encoded is equal to the or one predetermined value, the first information can be very compact, e.g. a single bit if there is only 1 predetermined value and 2 bits if there are 2 predetermined values, the first bit indicating that the mode value to be encoded is equal to one of the two predetermined values, and the second bit being an index indicating which one of the two predetermined values.

The or each predetermined value may be a mode value which is expected to occur most frequently. Such a mode value may be referred to as a most probable mode (MPM) value. Such a predetermined value may be determined in several different ways, for example through prior knowledge of the content of the video data (if available), or through the results of the encoding of other parts of the video data that has already been carried out.

For example, the predetermined values may be the mode values encoded from other coding units. In a preferred embodiment the mode value to be encoded relates to a current encoding unit to be encoded and the or each predetermined value is a previously-encoded mode value relating to an encoding unit neighbouring the current encoding unit. In the current HEVC design, for example, two encoding units are used to identify the MPM value(s), namely the top and left encoding units.

The coding efficiency may be improved by eliminating duplicate predetermined values. In a preferred embodiment the respective previously-encoded mode values relating to two or more encoding units neighbouring the current encoding unit are compared and the number of predetermined values is one if the respective mode values of two or more encoding are the same, and is two or more if the respective mode values of the two or more encoding units are different. In the current HEVC design, for example, this leads to 1 or 2 MPM values, depending on whether the top and left mode values are the same or different.

Preferably, the method comprises storing information representing the outcome of one or more prior first encoding processes, and taking account of the stored information in the encoding by the second encoding process. This is one way to establish a link between the first and second processes.

Of course, the second encoding process preferably also takes account of the outcome of prior second encoding processes as well as the outcome of prior first encoding processes. Thus, in another preferred embodiment the method comprises storing information representing the outcome of one or more first encoding processes and one or more second encoding processes, and taking account of the stored information in the encoding by the second encoding process.

It is also preferable for the first encoding process to take account of prior encoding processes, either of the first kind or the second kind, or both kinds. In one embodiment, therefore, the method comprises storing information representing the outcome of one or more prior first or second encoding processes, and taking account of the stored information in the encoding by the first encoding process.

The stored information can take several different forms.

In one embodiment, the stored information comprises probability information representing probabilities of occurrence of the encodable mode values. One effective way to obtain such probability information is to store information about one or more prior occurrences of the encodable mode values, i.e. a kind of occurrence record or history. For example, the probability information may comprise a count value for each encodable mode value, and the method comprises updating the count value for the mode value to be encoded when that mode value is encoded by the first encoding process. Counters suitable for this purpose may already be present in HEVC designs, so the additional overhead is minimal.

Alternatively, or in addition, the stored information may comprise probability ranking information representing a ranking of the encodable mode values according to their probabilities of occurrence. Such ranks may be easily manipulated in the second encoding process and the second information may be derived from the rank of the mode value to be encoded. Also, the outcome of the first (and second) encoding process may be recorded by simple manipulations of the ranks.

In a preferred embodiment, the second encoding process comprises deriving the second information from the mode value to be encoded and probabilities of occurrence of the mode value to be encoded and of the or each predetermined value. This enables the second information to be adjusted in the light of the relative probabilities of the mode value to be encoded and the predetermined values.

Preferably, the second information is derived from a rank of the mode value to be encoded in a ranking of the encodable mode values according to their probabilities of occurrence. Because the ranks reflect the probabilities of the modes in a simple and compact way, it is effective to use the rank of the mode value to be encoded to derive the second information. The second information can be used, for example, as an index into a VLC table. Alternatively, the second encoding process comprises binarising the derived second information to generate bins and applying arithmetic coding to the bins. The more probable the mode value (i.e. the lower the rank), the more compact the encoded second information should be. Deriving the second information from the rank can achieve this.

In a preferred embodiment, the second information is set equal to the rank of the mode value to be encoded when that rank is lower than the rank of the or each predetermined value, and is set lower than the rank of the mode value to be encoded when that rank is greater than or equal to the rank of at least one predetermined value. For example, if there is 1 MPM value, then the rank of the mode value is decremented by 1 in the event that this rank is greater than or equal to the 1 MPM value. If there are 2 MPM values, then the rank of the mode value is decremented by 1 or 2 depending on whether or not greater than or equal to each MPM value.

Preferably, the method comprises swapping the respective ranks of the mode value to be encoded and the mode value, if any, whose rank immediately precedes the rank of the mode value to be encoded. The swapping may be carried out after each first and second encoding process.

This is a simple but effective way to record the outcome of the first and/or second process.

In one embodiment the second encoding process has at least first and second coding tables of different sizes, the first coding table being used when there is a first number of predetermined values and the second coding table being used when there is a second number of predetermined values different from the first number, and the second information being used as index information for both the first and second coding tables, and a common index table is used to derive the index information for both the first and second tables from the mode value to be encoded. For example, when the encoding unit size is 4×4, there are 17 encodable mode values (N=17). The first coding table (VLC table) may then be of size N-2 (=15) and the second coding table (VLC table) may then be of size N-1 (=16). The common index table will be of size N (=17). It is not necessary to use a first index table of size N-2 and a second index table of size N-1, as in the current HEVC design described with reference to FIGS. 4 and 5 above. This provides a useful memory saving.

In one embodiment, in the first encoding process, when there are two or more predetermined values, the first information is dependent on an order of probability of occurrence of the predetermined values. This can improve the coding efficiency of the first encoding process. In particular, one bit of the first information may be used as an index to indicate which of the predetermined values (MPM values) the mode value to be encoded is equal to. It is desirable for this bit to be coded as a ‘0’ more often than as a ‘1’. By making the more probable MPM value correspond to bit ‘0’, this result can be achieved. In the current HEVC design, in contrast, the order of the predetermined values is based on the mode values themselves, with the first MPM value (MPM) being the lower of the two MPM values and the second MPM value (MPM2) being the higher of the two MPM values.

Incidentally, this problem can be solved even if the second encoding process does not take account of the outcome of the prior encoding processes as in the first aspect of the invention. Thus, according to another aspect of the present invention there is provided a method of encoding a mode value representing a prediction mode, comprising selecting from among at least first and second encoding processes an encoding process to apply to the mode value to be encoded, the first encoding process comprising encoding first information indicating a predetermined relationship between the mode value to be encoded and at least one predetermined value, and the second encoding process comprising encoding second information representing the mode value to be encoded. In the first encoding process, when there are two or more predetermined values, the first information is dependent on an order of probability of occurrence of the predetermined values.

This aspect of the present invention is applicable to the methods described with reference to FIGS. 2 to 5, as well as to the methods described with reference to FIGS. 6 to 9.

According to a second aspect of the present invention there is provided apparatus for encoding a mode value representing a prediction mode. The apparatus comprises first encoding means for carrying out a first encoding process comprising encoding first information indicating a predetermined relationship between the mode value to be encoded and at least one predetermined value. The apparatus also comprises second encoding means for carrying out a second encoding process comprising encoding second information representing the mode value to be encoded. The apparatus further comprises selecting means for selecting, from among at least the first and second encoding processes, an encoding process to apply to the mode value to be encoded; wherein the second encoding means is adapted to take account of the outcome of at least one prior first encoding process when carrying out the second encoding process.

According to a third aspect of the present invention there is provided a computer-readable storage medium storing a program which, when run on a computer or processor, causes the computer or processor to carry out a method embodying the first aspect of the present invention.

As described above, by taking into account the outputs of process 1 for the updating of the modes probabilities, the coding efficiency can be improved.

Thanks to this solution, it is no more necessary in the CAVLC case to maintain 2 index tables of size N-2 and N-1 for a given CU size. One single table of size N for the N considered modes is required. This table is directly linked to the modes. In total, 2 tables of size 17 and 34 instead of 4 tables of size 15, 16, 32, 33 are needed, which reduces the memory needs. Thus the memory requirements are reduced.

In the SBAC case, the binarization can be improved by taking into account the modes probabilities. This will improve the coding efficiency.

### BRIEF DESCRIPTION OF THE DRAWINGS

FIGS. 1A and 1B, discussed hereinbefore, are schematic diagrams for use in explaining how an intra prediction block is derived in the current HEVC design;

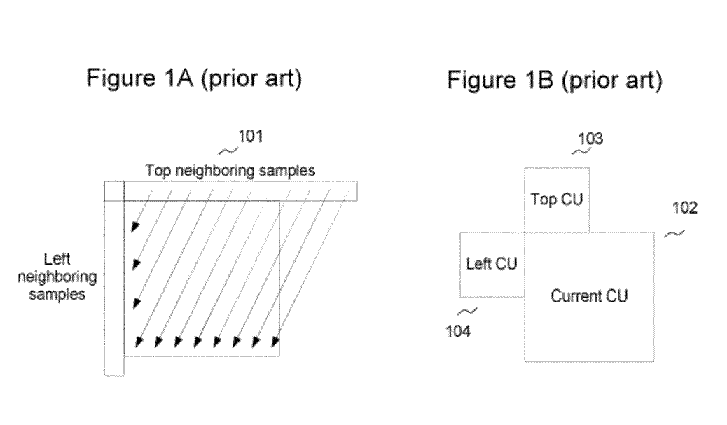

FIG. 2, also discussed hereinbefore, is a flowchart for use in explaining intra mode coding in the current HEVC design;

FIG. 3, also discussed hereinbefore, is a flowchart for use in explaining intra mode coding using SBAC in the current HEVC design;

FIG. 4, also discussed hereinbefore, is a flowchart for use in explaining intra mode coding using CAVLC in the current HEVC design;

FIG. 5, also discussed hereinbefore, is a schematic diagram illustrating one example of the operation of the intra mode coding of FIG. 4;

FIG. 6 is a flowchart for use in explaining a principle of intra mode coding according to the present invention;

FIG. 7 is a flowchart for use in explaining intra mode coding using SBAC according to a first embodiment of the present invention; and

FIG. 8 is a flowchart for use in explaining intra mode coding using CAVLC according to a second embodiment of the present invention.

FIG. 9 is a schematic diagram illustrating one example of the operation of the second embodiment;

FIG. 10 shows a sequence of images;

FIG. 11 shows parts of apparatus suitable for implementing an encoder according to an embodiment of the present invention;

FIG. 12 shows a block diagram of parts of an encoder according to an embodiment of the present invention; and

FIG. 13 illustrates a block diagram of parts of a decoder.

### DETAILED DESCRIPTION OF THE EMBODIMENTS

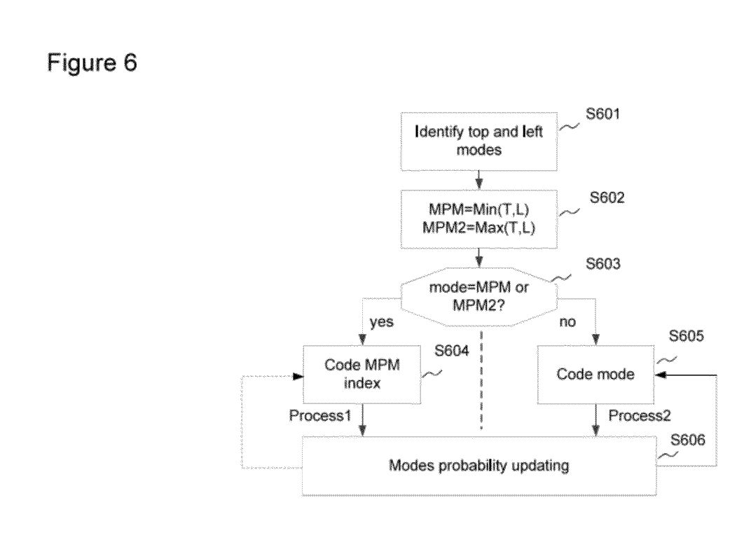

FIG. 6 is a flowchart for use in explaining a principle of an intra mode coding method embodying the present invention. The intra mode coding method according to this flowchart is applicable to SBAC, CAVLC and other entropy coding engines such as CABAC.

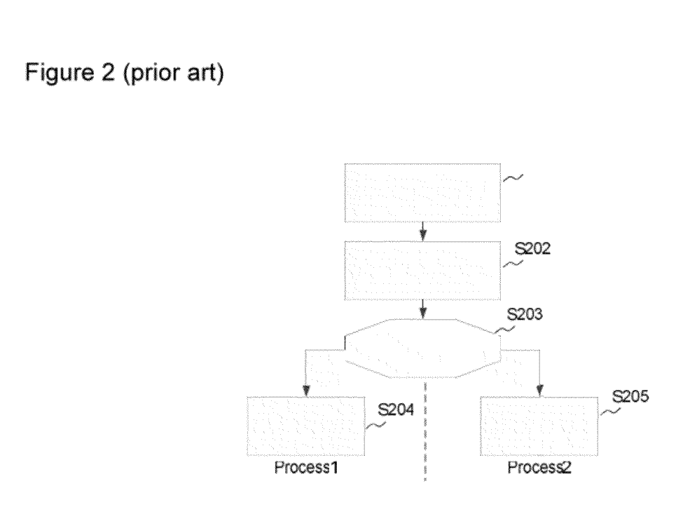

In FIG. 6, steps S601, S602 and S603 are the same as steps S201, S202 and S203, respectively, in FIG. 2, and the description of these steps is not repeated here.

Process 1, which is carried out when the mode of the current block is equal to the one MPM or to one of the two MPMs, is implemented in step S604. In some embodiments of the present invention, in particular embodiments intended to implement CAVLC, step S604 can be the same as step S204 in FIG. 2. However, optionally, step S604 can be modified as compared to step S204, and this is shown schematically in FIG. 6 by the dotted connection into S604 which is not present in S204.

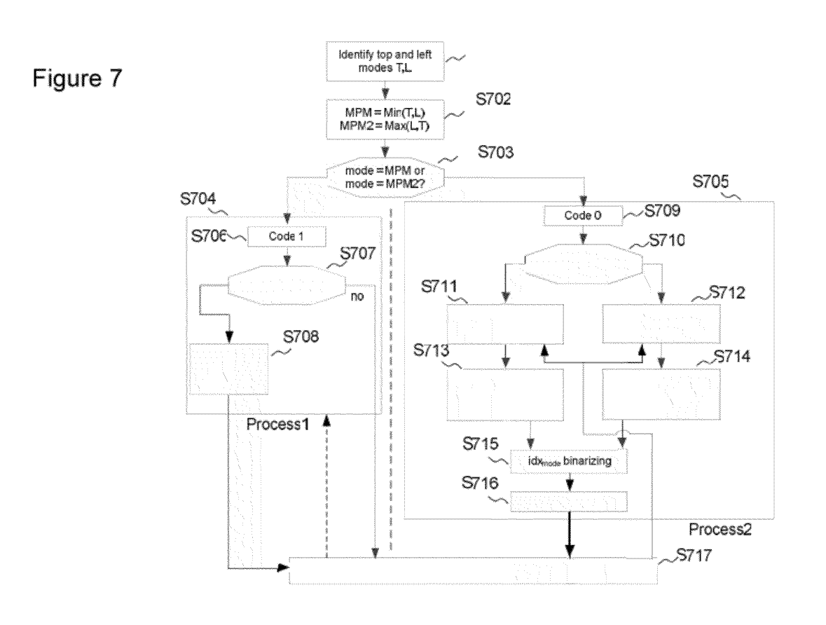

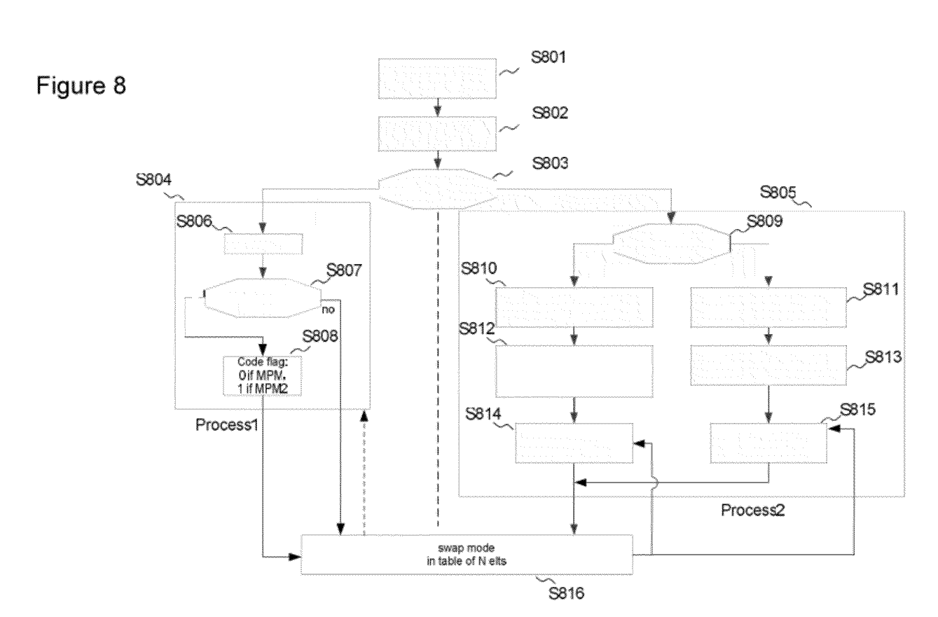

Process 2, which is carried out when the mode of the current block is different from the or each MPM, is implemented in step S605. This step is different from the corresponding step S205 in FIG. 2, as will be described later with reference to FIGS. 7 and 8.

The intra mode coding method of FIG. 6 also comprises an additional step S606, which was not present in FIG. 2. This establishes an explicit link between process 1 and process 2. Mode probabilities are defined and they are systematically updated once the process 1 or process 2 has been applied. Step S606 uses as input the mode coded either via process 1 or via process 2 and updates the mode probabilities based on this input. The updated probabilities are then further used at least for the mode coding of process 2 in S605. In addition, optionally, process 1 can also take into account these probabilities as depicted by the dotted connection from S606 to S604 in FIG. 6.

In the method of FIG. 6 there is now a link between the two coding processes invoked in intra mode coding. In particular, the mode probabilities used in process 2 can take the benefit from what happens in process 1. This improves coding efficiency.

In particular, in certain images there is a dominant background mode over the picture as a whole but at certain positions foreground objects interrupt the dominant mode. After coding the CUs of foreground objects, background mode CUs reappear but, without a link between processes 1 and 2, these background mode CUs are coded without any priority. When there is frequent switching between a dominant mode and other modes, this may result in loss of coding efficiency. By making a link between the processes 1 and 2, it is possible to avoid forgetting the MPM when it is not used.

FIG. 7 is a flowchart for use in explaining an intra coding method according to a first embodiment of the present invention. This embodiment is applied to an SBAC entropy coding engine.

Compared to the present HEVC design for SBAC, a first modification is the introduction of new tables, used to store and to update the probabilities of the coding modes. Two probability tables are added, one of 17 elements for the 4×4 blocks, and another one of 34 elements for the 8×8 to 32×32 blocks.

Each probability table has an entry per mode value m (m=0, 1, . . . N-1) which stores the value proba[m] of the probability of m. The probability value is represented by a fixed number of bits, for example 8. In this case, the range of the probability values is from 0 to 255. These probability values are updated based on the outcomes of processes 1 and 2, as described below.

Optionally, two index (rank) tables can also be used, that are also adaptively updated based on the probability value of each mode. In these tables, the index (rank) of a mode indicates its order according to its probability. The mode with the highest probability has an index equal to 0, and the mode with the lowest probability has an index equal to N-1.

Steps S701, S702 and S703 are the same as steps S301, S302 and S303, respectively, and are not described further here.

When the current mode is equal to the one MPM or to one of the two MPMs, process 1 is carried out. Steps S706, S707 and S708 are the same as steps S306, S307 and S308, respectively, and are not described further here.

After process 1 has been carried out, processing jumps to step S717, which is described below.

When the mode is different from the or each MPM, process 2 is carried out. Firstly, in step S709 the bit-value ‘0’ is coded to signal that the mode is not a MPM. The number of identified MPMs is then checked in step S710.

Then the index (rank) of the current mode, and of the or each MPM, is identified based on the probability value of the mode or MPM concerned. If an index table is used, this can be used to directly look up the rank. If no index table is used, the rank must be determined by comparing the probability values in the probability table. As explained above, the mode with the highest probability has an index equal to 0, and the mode with the lowest probability has an index equal to N-1. Depending on the number of MPMs, one related MPM index is identified, as in step S712, or two related MPM indices are identified, as in step S711.

In step S714 the index of the current mode is decremented by 1 if the related MPM index is lower than the current mode index. Thus, the current mode index may stay the same or be decremented by 1 in S714. In step S713 the index of the current mode is decremented by 1 for each related MPM index which is less than the current mode index. Thus, depending on the related MPM indices, the current mode index may stay the same or may be decremented by 1 or 2 in step S713.

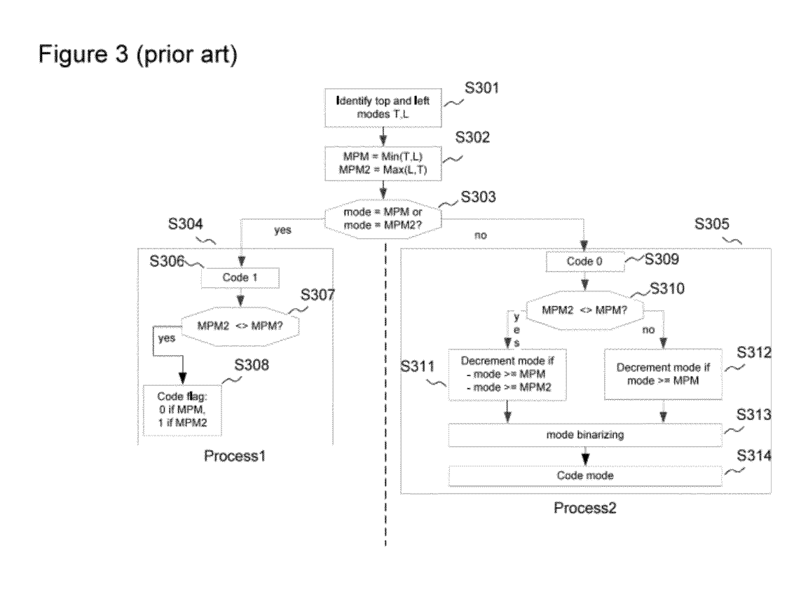

The resulting index value is then binarized in step S715. The binarization is not applied to the decremented mode as in the current HEVC design (step S313 in FIG. 3), but on the decremented index (rank) of the mode. Compared to the previous design, the probabilities can be further exploited to improve the binarization process. Indeed a mode with a small rank is highly probable and could therefore be binarized using a shorter representation than more rare modes (similarly to how VLC works).

In a preferred implementation, the binarization works as follows.
Case of 4×4 block—17 modes are supported
If index is 0, the codeword ‘000’ is coded
Else 4 or 5 bits are used to code the index
Case of 8×8 to 32×32 block—34 modes are supported
If index is 0, the codeword ‘0000’ is coded
Else 5 or 6 bits are used to code the index

Therefore the index 0 uses fewer bits, which finally results in an improved coding efficiency. In addition, this implementation of the binarization generates more bins 0 than bins 1 (since the most frequent codeword is ‘000’). Also small index values are coded more often (since they are more probable), and these small values, once binarized, tend to have more 0s than 1s (‘1’ binarized on 4 bins gives ‘0001’, 15 gives ‘1111’). So the probability of 0 is higher than probability of 1, which makes the arithmetic coding performing better.

Finally, in step S716 each bin of the binarized value is coded.

Once process 1 or process 2 has been applied, the probability table is updated in step S717. Let m be the mode number, and proba[m] be the value of the probability of m. The updating process works as follows:
Increment the probability of m

proba[m]=proba[m]+1
If proba[m] reaches the maximum authorized value in the probability range (this value is pre-defined; for example, as noted above it may be a value of 255, corresponding to 8 bits to represent the probability), the full probability table is reset as follows:

For (n=0 to N-1)

proba[n]=proba[n]/2;

This has the effect of halving each probability value, whilst preserving the rankings.

If a rank table is used, it is also updated based on the updated probabilities. The rank of m is decremented if proba[m]—after being updated—is larger than its immediately preceding mode in the rank table.

Then for all the modes whose rank is greater than or equal to the new rank of m, the rank is incremented by 1.

In a simplified version, the ordering process is based on simple rank switching. The rank of the current mode m is switched with the rank of its preceding mode (having the immediately lower rank value) if the current mode m has a higher probability value. Similarly the following mode (having the immediately larger rank value) can also be checked and its rank switched with the rank of m if its probability is higher than the probability of the current mode m.

When process 2 is executed subsequently it can then use the updated probability table, or the updated rank table, to identify the mode rank (steps S711 and S712).

As described above, the first embodiment introduces a new table of size N (N depending on the CU size), which is used as a probability table. This table is updated once process 1 or process 2 has been applied, according to the coded mode value. Process 2 is also modified in such a way that instead of coding the mode value, its rank according to the probability table is coded.

In the first embodiment, as described above, process 1 does not take into account the probabilities of the modes. However, a variant of the first embodiment is possible which enables process 1 to take account of the probabilities of the modes, too. In this variant, step S708 is modified to take into account the order of probabilities of the MPMs when MPM< >MPM2:
If the probability of MPM is greater than or equal to the probability of MPM2, flag 0 signifies mode=MPM, flag 1 signifies mode=MPM2
Otherwise (i.e. if the probability of MPM2 is greater than the probability of MPM), flag 0 signifies mode=MPM2, flag 1 signifies mode=MPM

Thus, in process 1, when two different MPMs are present (yes in S707), instead of ordering the MPMs according to their mode values (MPM being the one with the smaller mode value and MPM2 being the one with the larger mode value), the ordering is done according to the MPM mode probability. The MPM which has the highest probability is ordered first. In case of equal probabilities, the first MPM is as before the one with the minimum mode value.

In this variant, in the SBAC case, the binarization can be improved by taking into account the mode probabilities. This will improve the coding efficiency.

Incidentally, in this variant step S702 is not modified, and initially the MPMs are ordered according to their mode values. However, in another variant of the first embodiment it would also be possible to directly modify step S702 to generate the same behavior without modifying step S708.

FIG. 8 is a flowchart for use in explaining an intra coding method according to a second embodiment of the present invention. This embodiment is applied to a CAVLC entropy coding engine.

Compared to the present HEVC design for CAVLC, a first modification is the reduction in the number of required index tables. In the current HEVC design, 4 index tables are used: 2 for the 4×4 blocks case (one table of 15 elements and one table of 16 elements), and 2 for the 8×8 to 32×32 blocks case (one table of 32 elements and one table of 33 elements). In the present embodiment, two index tables of N elements are needed, where N is the number of modes available for the block size. For example, it is currently contemplated to have one table of 17 elements for the 4×4 blocks case and one table of 34 elements for the 8×8 to 32×32 blocks case.

These new tables are directly related to the modes, which was not true in the previous design.

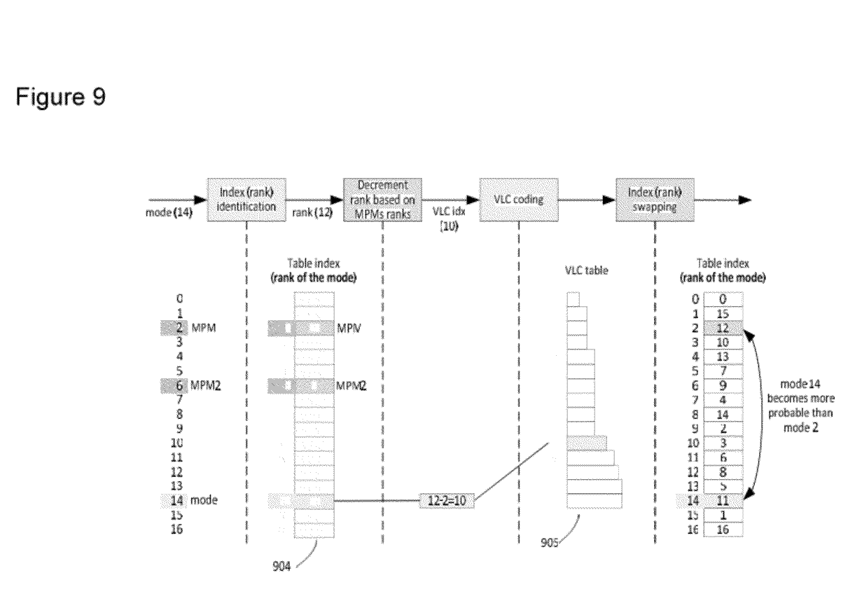

FIG. 9 shows an example of an index table 904 for the 4×4 blocks case.

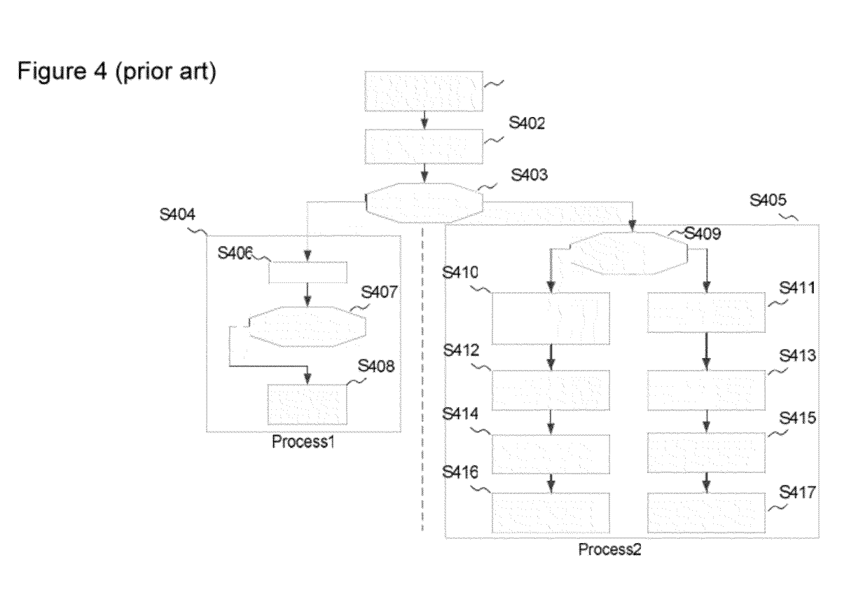

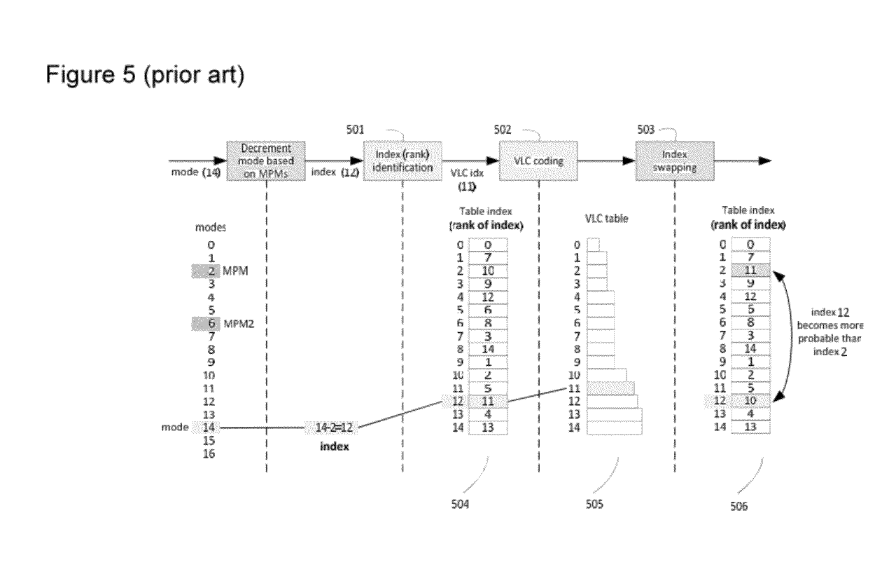

There is no change to the VLC tables described with reference to FIGS. 4 and 5. Thus, a first VLC table of size N-1 and a second VLC table of size N-2 are required for the 4×4 blocks case (one VLC table of 15 elements and one VLC table of 16 elements) and a third VLC table of size N-1 and a fourth VLC table of size N-2 are required for the 8×8 to 32×32 blocks case (one VLC table of 32 elements and one VLC table of 33 elements).

FIG. 9 also shows an example of the second VLC table 905 for the 4×4 blocks case.

Steps S801, S802 and S803 are the same as steps S401, S402 and S403, respectively, and are not described further here.

When the current mode is equal to the one MPM or to one of the two MPMs, process 1 is carried out. Steps S806, S807 and S808 are the same as steps S406, S407 and S408, respectively, and are not described further here.

After process 1 has been carried out, processing jumps to step S816, which is described below.

When the mode is different from the or each MPM, process 2 is applied and works as follows. In step S809 the number of identified MPMs is checked.

Then in step S810 or S811 the rank of the current mode, and of the or each MPM, is identified using the index table of N elements. Depending on the number of MPMs, one (S811) or two (S810) related MPM ranks are identified. In the example illustrated in FIG. 9, the number of MPMs identified is 2. The mode value of the current mode is 14. The mode values of MPM and MPM2 are 2 and 6 respectively. Using the index table 904 the rank of the current mode is found to be 12, and the ranks of MPM and MPM2 are found to be 11 and 9 respectively.

An index into the VLC table is derived from the current mode rank in dependence upon the or each related MPM rank. Initially the index is set equal to the current mode rank. In step S813 the index of the current mode is decremented by 1 if the related MPM rank is lower than the current mode rank. Thus, the current mode index may be equal to the original rank or may be 1 less than it as a result of step S813. In step S812 the index of the current mode is decremented by 1 for each related MPM rank which is less than the current mode rank. Thus, depending on the related MPM ranks, the current mode index may be equal to the original rank or may be 1 or 2 less than it as a result of step S812.

In the example of FIG. 9, the number of MPMs is two, both of which are lower in rank (11, 9) than the original rank of the current mode (12). Accordingly, the index of the current mode becomes 10, which is 2 less than the original rank.

Then the index, decremented as necessary in S812 or S813, is coded using VLC. If two MPMs are present, then in step S814 the index is coded using the VLC having the same index, obtained from the relevant VLC table 905 of size N-2. If one MPM is present, then in step S815 the index is coded using the VLC having the same index, obtained from VLC table of size N-1.

In the current HEVC design using CAVLC, the index table swapping process (S416 or S417 in FIG. 4) is applied as the last step of process 2. In contrast, in the present embodiment, this swapping process is now outside process 2, in a new step S816. In addition, this swapping process is applied whether process 1 or process 2 is used. It directly takes as input the current mode value, rather than the index value derived there from, and the swapping applies to the input mode value and the mode value of rank immediately preceding the rank of the current mode value.

In the example of FIG. 9, the current mode value is 14 which has rank 12. Mode value 2 has the immediately preceding rank 11. Thus, the ranks of mode values 14 and 2 are swapped and become 11 and 12 respectively, as shown in the updated index table 906.

When process 2 is executed subsequently it can then use the updated index table 906 to identify the mode rank (steps S810 and S811).

As described above, the second embodiment replaces the 2 index tables of size N-2 and N-1 by a single index table of size N. This table is updated once process 1 or process 2 has been applied, according to the coded mode value. Process 2 is also modified in such a way that instead of coding the mode value, its rank according to the probability table is coded.

Accordingly, it is no longer necessary in the CAVLC case to maintain 2 index tables of size N-2 and N-1 for a given CU size. One single table of size N is required for the N modes available for the given CU size. This table is directly linked to the modes. In total, 2 tables of size 17 and 34 instead of 4 tables of size 15, 16, 32, 33 are needed, which reduces the memory needs.

In the second embodiment, as described above, process 1 does not take into account the probabilities of the modes. However, a variant of the second embodiment is possible which enables process 1 to take account of the probabilities of the modes, too. In this variant, step S808 is modified to take into account the order of probabilities of the MPMs when MPM< >MPM2:
If the probability of MPM is greater than or equal to the probability of MPM2, flag 0 signifies mode=MPM, flag 1 signifies mode=MPM2
Otherwise (i.e. if the probability of MPM2 is greater than the probability of MPM), flag 0 signifies mode=MPM2, flag 1 signifies mode=MPM

Thus, in process 1, when two different MPMs are present (yes in S807), instead of ordering the MPMs according to their mode values (MPM being the one with the smaller mode value and MPM2 being the one with the larger mode value), the ordering is done according to the MPM mode probability. The MPM which has the highest probability is ordered first. In case of equal probabilities, the first MPM is as before the one with the minimum mode value.

In this variant, in the CAVLC case, the binarization of the MPM index can be improved by taking into account the mode probabilities. This will improve the coding efficiency.

Incidentally, in this variant step S802 is not modified, and initially the MPMs are ordered according to their mode values. However, in another variant of the first embodiment it would also be possible to directly modify step S802 to generate the same behavior without modifying step S808.

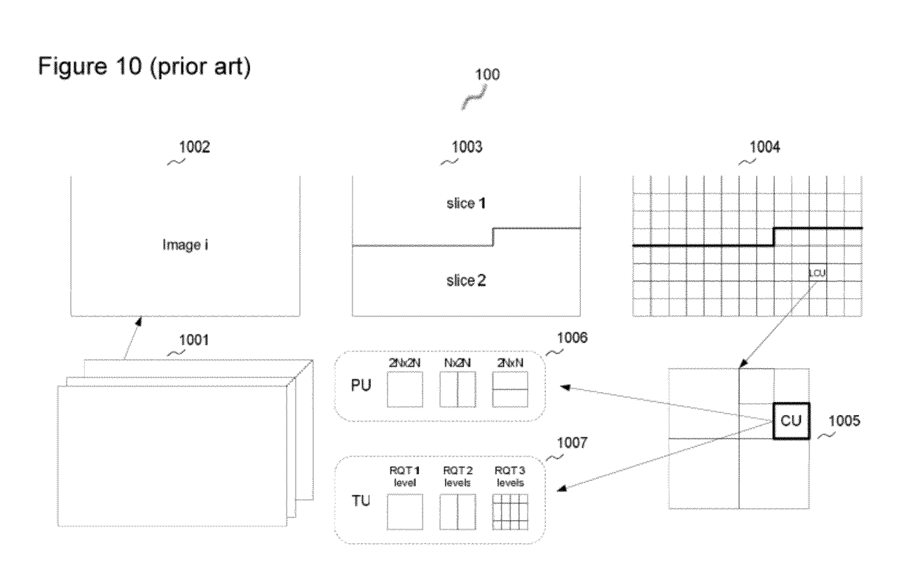

FIG. 10 shows the image coding structure 100 used in HEVC. According to HEVC and one of its previous predecessors, the original video sequence 1001 is a succession of digital images “images i”. As is known per se, a digital image is represented by one or more matrices the coefficients of which represent pixels.

The images 1002 are divided into slices 1003. A slice is a part of the image or the entire image. In HEVC these slices are divided into non-overlapping Largest Coding Units (LCUs) 1004, generally blocks of size 64 pixels×64 pixels. Each LCU may in its turn be iteratively divided into smaller variable size Coding Units (CUs) 1005 using a quadtree decomposition. Each CU can be further partitioned into a maximum of 2 symmetric rectangular Partition Units 1006.

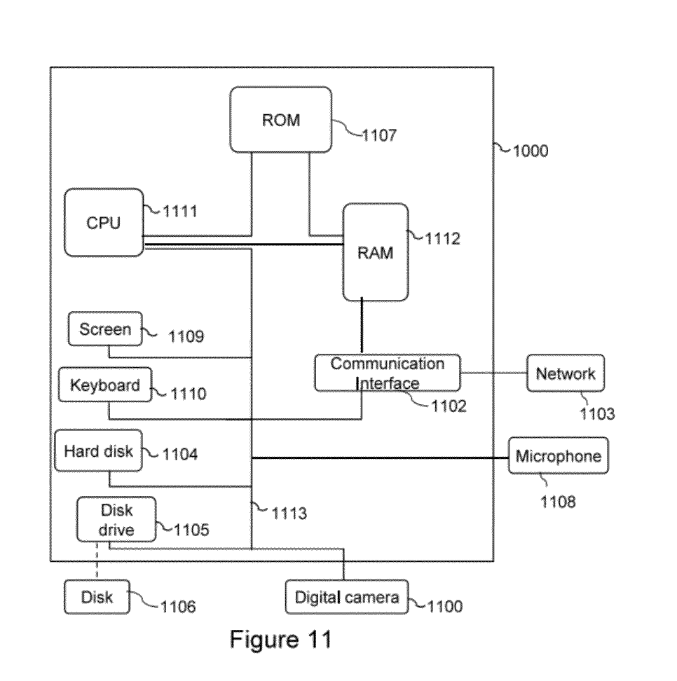

FIG. 11 illustrates a diagram of apparatus 1000 adapted to implement an encoder according to an embodiment of the present invention or to implement a decoder. The apparatus 1000 is for example a micro-computer, a workstation or a light portable device.

The apparatus 1000 comprises a communication bus 1113 to which there are preferably connected:
a central processing unit 1111, such as a microprocessor, denoted CPU;
a read only memory (ROM) 1107 which stores one or more computer programs for implementing the invention;
a random access memory (RAM) 1112 which stores executable code of the method of the invention and provides registers adapted to record variables and parameters necessary for implementing the method of encoding a sequence of digital images and/or the method of decoding a bitstream; and
a communication interface 1102 connected to a communication network 1103 over which digital data to be processed are transmitted.

Optionally, the apparatus 1000 may also have the following components:
a data storage means 1104 such as a hard disk, able to contain the programs implementing the invention and data used or produced during the implementation of the invention;
a disk drive 1105 for a disk 1106, the disk drive being adapted to read data from the disk 1106 or to write data onto the disk;
a screen 1109 for displaying data and/or serving as a graphical interface with the user, by means of a keyboard 1110 or any other pointing means.

The apparatus 1000 can be connected to various peripherals, such as for example a digital camera 1100 or a microphone 1108, each being connected to an input/output card (not shown) so as to supply multimedia data to the apparatus 1000.

The communication bus affords communication and interoperability between the various elements included in the apparatus 1000 or connected to it. The representation of the bus is not limiting and in particular the central processing unit is able to communicate instructions to any element of the apparatus 1000 directly or by means of another element of the apparatus 1000.

The disk 1106 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of encoding a sequence of digital images and/or the method of decoding a bitstream according to the invention to be implemented.

The executable code may be stored either in read only memory 1107, on the hard disk 1104 or on a removable digital medium such as for example a disk 1106 as described previously. According to a variant, the executable code of the programs can be received by means of the communication network 1103, via the interface 1102, in order to be stored in one of the storage means of the apparatus 1000 before being executed, such as the hard disk 1104.

The central processing unit 1111 is adapted to control and direct the execution of the instructions or portions of software code of the program or programs according to the invention, instructions that are stored in one of the aforementioned storage means. On powering up, the program or programs that are stored in a non-volatile memory, for example on the hard disk 1104 or in the read only memory 1107, are transferred into the random access memory 1112, which then contains the executable code of the program or programs, as well as registers for storing the variables and parameters necessary for implementing the invention.

In this embodiment, the apparatus is a programmable apparatus which uses software to implement the invention. However, alternatively, the present invention may be implemented in hardware (for example, in the form of an Application Specific Integrated Circuit or ASIC).

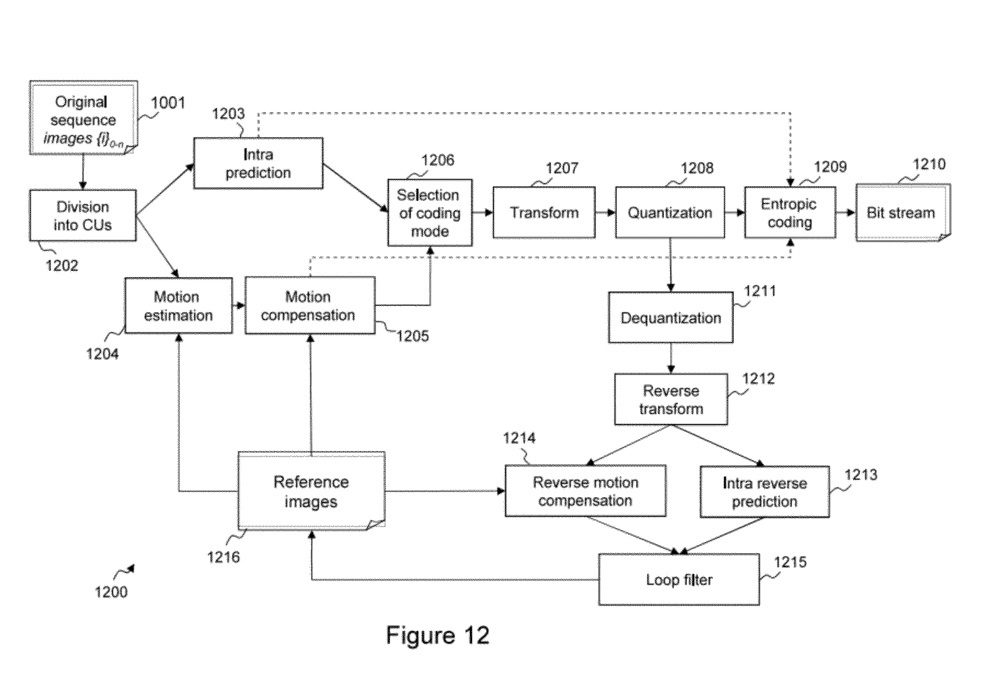

FIG. 12 illustrates a block diagram of an encoder 1200 according to an embodiment of the invention. The encoder is represented by connected modules, each module being adapted to implement, for example in the form of programming instructions to be executed by the CPU 1111 of apparatus 1000, a corresponding step of a method implementing an embodiment of the invention.

An original sequence of digital images i₀ to iₙ 1001 is received as an input by the encoder 1200. Each digital image is represented by a set of samples, known as pixels.

A bitstream 1210 is output by the encoder 1200.

Note that, in the following description we sometimes use the term “block” in place of the specific terminology CU and PU used in HEVC. A CU or PU is a block of pixels.

The input digital images i are divided into blocks by module 1202. These blocks are image portions and may be of variable sizes (e.g. 4×4, 8×8, 16×16, 32×32, 64×64).

During video compression, each block of an image being processed is predicted spatially by an “Intra” predictor module 1203, or temporally by an “Inter” predictor module comprising a motion estimation module 1204 and a motion compensation module 1205. Each predictor is a block of pixels issued from the same image or another image, from which a difference block (or “residual”) is derived. Thanks to the identification of the predictor block and the coding of the residual, it is possible to reduce the quantity of information actually to be encoded.

The encoded frames are of two types: temporal predicted frames (either predicted from one reference frame called P-frames or predicted from two reference frames called B-frames) and non-temporal predicted frames (called Intra frames or I-frames). In I-frames, only Intra prediction is considered for coding CUs/PUs. In P-frames and B-frames, Intra and Inter prediction are considered for coding CUs/PUs.

In the “Intra” prediction module 1203, the current block is predicted by means of an “Intra” predictor, a block of pixels constructed from the information already encoded of the current image.

With regard to the “Inter” coding, two prediction types are possible. Mono-prediction (P-type) consists of predicting the block by referring to one reference block from one reference picture. Bi-prediction (B-type) consists of predicting the block by referring to two reference blocks from one or two reference pictures. An estimation of motion is carried out by module 1204 between the current CU or PU and reference images 1216. This motion estimation is made in order to identify, in one or several of these reference images, one (P-type) or several (B-type) blocks of pixels to use them as predictors of this current block. In a case where several block predictors are used (B-type), they are merged to generate one single prediction block. The reference images used consist of images in the video sequence that have already been coded and then reconstructed (by decoding).

Generally, the motion estimation carried out by module 1204 is a block matching algorithm (BMA).

The predictor obtained by the algorithm is then subtracted from the current data block to be processed so as to obtain a difference block (block residual). This processing is called “motion compensation” and is carried out by module 1205.

These two types of coding thus supply several texture residuals (the difference between the current block and the predictor block), which are compared in a module 1206 for selecting the best coding mode.

If “Intra” coding is selected, an item of information for describing the “Intra” predictor used is coded by an entropic encoding module 1209 before being inserted in the bit stream 1210. Embodiments of the present invention described hereinbefore with reference to FIGS. 6 to 9 are applicable to the entropic encoding module 1209 in FIG. 12.

If the module 1206 for selecting the best coding mode chooses “Inter” coding, motion information is coded by the entropic encoding module 1209 and inserted in the bit stream 1210. This motion information is in particular composed of one or several motion vectors (indicating the position of the predictor block in the reference images relative to the position of the block to be predicted) and an image index among the reference images.

The residual obtained according to the coding mode selected by the module 1206 is then transformed by module 1207. The transform applies to a Transform Unit (TU), that is included into a CU. A TU can be further split into smaller TUs 1006 using a so-called Residual QuadTree (RQT) decomposition. In HEVC, generally 2 or 3 levels of decompositions are used and authorized transform sizes are from 32×32, 16×16, 8×8 and 4×4. The transform basis is derived from a discrete cosine transform DCT.

The residual transformed coefficients are then quantized by a quantization module 1208. The coefficients of the quantized transformed residual are then coded by means of the entropic coding module 1209 and then inserted in the compressed bit stream 1210.

In order to calculate the “Intra” predictors or to make an estimation of the motion for the “Inter” predictors, the encoder performs a decoding of the blocks already encoded by means of a so-called “decoding” loop 1211-1215. This decoding loop makes it possible to reconstruct the blocks and images from the quantized transformed residuals.

The quantized transformed residual is dequantized in module 1211 by applying the reverse quantization to that provided by module 1208 and reconstructed in module 1212 by applying the reverse transform to that of the module 1207.

If the residual comes from an “Intra” coding, then in module 1213 the used “Intra” predictor is added to this residual in order to recover a reconstructed block corresponding to the original block modified by the losses resulting from a transformation with loss, here quantization operations.

If the residual on the other hand comes from an “Inter” coding, the blocks pointed to by the current motion vectors (these blocks belong to the reference images 1216 referred to by the current image indices) are merged then added to this decoded residual in module 1214. In this way the original block, modified by the losses resulting from the quantization operations, is obtained.

A final loop filter 1215 is applied to the reconstructed signal in order to reduce the effects created by heavy quantization of the residuals obtained and to improve the signal quality. The loop filter comprises two steps, a “deblocking” filter and a linear filtering. The deblocking filtering smoothes the borders between the blocks in order to visually attenuate these high frequencies created by the coding. The linear filtering further improves the signal using filter coefficients adaptively determined at the encoder. The filtering by module 1215 is thus applied to an image when all the blocks of pixels of this image have been decoded.

The filtered images, also called reconstructed images, are then stored as reference images 1216 in order to allow the subsequent “Inter” predictions taking place during the compression of the following images of the current video sequence.

In the context of HEVC, it is possible to use several reference images 1216 for the estimation and motion compensation of the current image. In other words, the motion estimation is carried out on N images. Thus the best “Inter” predictors of the current block, for the motion compensation, are selected in some of the multiple reference images. Consequently two adjoining blocks may have two predictor blocks that come from two distinct reference images. This is in particular the reason why, in the compressed bit stream, the index of the reference image (in addition to the motion vector) used for the predictor block is indicated.

The use of multiple reference images is both a tool for resisting errors and a tool for improving the compression efficacy. The VCEG group recommends limiting the number of reference images to four.

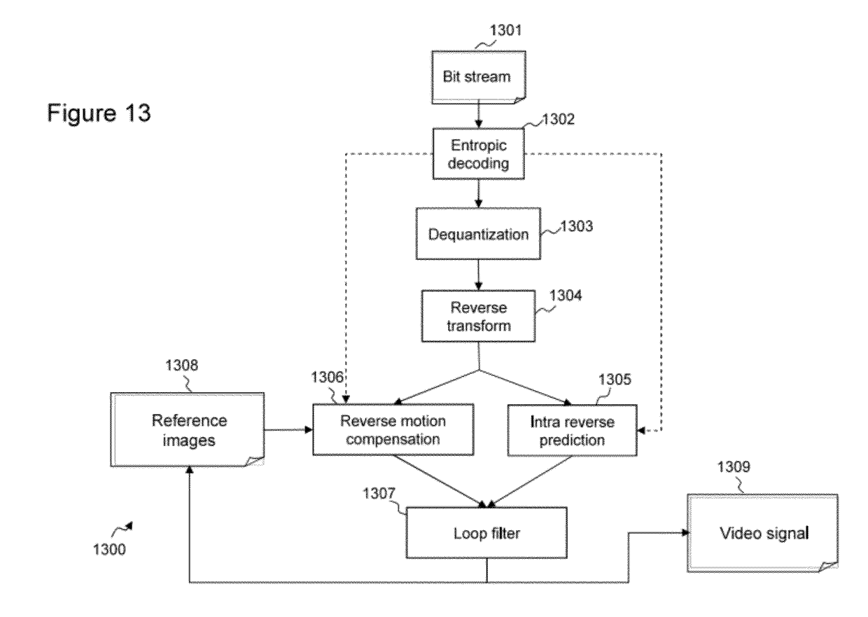

FIG. 13 illustrates a block diagram of a decoder 1300 according to an embodiment of the invention. The decoder is represented by connected modules, each module being adapted to implement, for example in the form of programming instructions to be executed by the CPU 1111 of apparatus 1000, a corresponding step of a method implementing an embodiment of the invention.

The decoder 1300 receives as an input a bit stream 1301 corresponding to a video sequence 1210 compressed by an encoder of the HEVC type, such as the one shown in FIG. 12.

During the decoding process, the bit stream 1301 is first of all decoded entropically by a module 1302.

The residual of the current block is then dequantized by a dequantization module 1303. This reverses the quantization carried out by the quantization module 1208 in the encoder 1200. The dequantized data is then reconstructed by a reverse transform module 1304 which performs a transformation the reverse of that carried out by the transform module 1207 in the encoder 1200.

The decoding of the data in the video sequence is then carried out image by image and, within an image, block by block.

The “Inter” or “Intra” coding mode for the current block is extracted from the bit stream 1301 and decoded entropically.

If the coding of the current block is of the “Intra” type, the number of the predictor is extracted from the bit stream and decoded entropically. The Intra predictor block associated with this index is recovered from the data already decoded of the current image.

The residual associated with the current block is recovered from the bit stream 1301 and then decoded entropically. Finally, the Intra predictor block recovered is added to the residual thus dequantized and reconstructed in a reverse Intra prediction module 1305 in order to obtain the decoded block.

If the coding mode of the current block indicates that this block is of the “Inter” type, the motion information is extracted from the bit stream 1301 by the entropic decoding module 1302 and decoded.

This motion information is used in a reverse motion compensation module 206 in order to determine the “Inter” predictor block contained in the reference images 1308 of the decoder 1300. In a similar manner to the encoder, these reference images 1308 are composed of images that precede the image currently being decoded and that are reconstructed from the bit stream (and therefore decoded previously).

The residual associated with the current block is, here also, recovered from the bit stream 1301 and then decoded entropically by module 1302. The Inter predictor block determined is then added to the thus dequantized residual reconstructed in the reverse motion compensation module 1306 in order to obtain the decoded block.

At the end of the decoding of all the blocks of the current image, the same loop filter 1307 as the filter 1215 provided at the encoder is used to eliminate the block effects and improve the signal quality in order to obtain the reference images 1308.

The images thus decoded constitute the output video signal 1309 of the decoder, which can then be displayed and used.

The embodiments described above are based on block partitions of input images, but more generally, any type of image portions to encode or decode can be considered, in particular rectangular portions or more generally geometrical portions.

More generally, any modification or improvement of the above-described embodiments, that a person skilled in the art may easily conceive should be considered as falling within the scope of the invention.

What is claimed is:

1. A method of encoding a mode value representing a prediction mode, comprising:
selecting from among at least first and second encoding processes an encoding process to apply to the mode value to be encoded, the first encoding process comprising encoding first information indicating a predetermined relationship between the mode value to be encoded and at least one predetermined value, and the second encoding process comprising encoding second information representing the mode value to be encoded;
wherein the encoding by the second encoding process takes account of the outcome of at least one prior first encoding process.

2. The method according to claim 1, wherein the first encoding process is selected when the mode value to be encoded is equal to the or one predetermined value, and the second encoding process is selected when the mode value to be encoded differs from the or each predetermined value.

3. The method according to claim 1, wherein the mode value to be encoded relates to a current encoding unit to be encoded and the or each predetermined value is a previously-encoded mode value relating to an encoding unit neighbouring the current encoding unit.

4. The method according to claim 3, wherein the respective previously-encoded mode values relating to two or more encoding units neighbouring the current encoding unit are compared and the number of predetermined values is one if the respective mode values of the two or more encoding units are the same, and is two or more if the respective mode values of the two or more encoding units are different.

5. The method according to claim 1, comprising storing information representing the outcome of one or more prior first encoding processes, and taking account of the stored information in the encoding by the second encoding process.

6. The method according to claim 1, comprising storing information representing the outcome of one or more first encoding processes and one or more second encoding processes, and taking account of the stored information in the encoding by the second encoding process.

7. The method according to claim 1, comprising storing information representing the outcome of one or more prior first or second encoding processes, and taking account of the stored information in the encoding by the first encoding process.

8. The method according to claim 5, wherein the stored information comprises probability information representing probabilities of occurrence of the encodable mode values.

9. The method according to claim 8, wherein the probability information comprises a count value for each encodable mode value, and the method comprises updating the count value for the mode value to be encoded when that mode value is encoded by the first encoding process.

10. The method according to claim 5, wherein the stored information comprises probability ranking information representing a ranking of the encodable mode values according to their probabilities of occurrence.

11. The method according to claim 1, wherein the second encoding process comprises deriving the second information from the mode value to be encoded and probabilities of occurrence of the mode value to be encoded and of the or each predetermined value.

12. The method according to claim 11, wherein the second information is derived from a rank of the mode value to be encoded in a ranking of the encodable mode values according to their probabilities of occurrence.

13. The method according to claim 12, wherein the second information is set equal to the rank of the mode value to be encoded when that rank is lower than the rank of the or each predetermined value, and is set lower than the rank of the mode value to be encoded when that rank is greater than or equal to the rank of at least one predetermined value.

14. The method according to claim 10, further comprising swapping the respective ranks of the mode value to be encoded and the mode value, if any, whose rank immediately precedes the rank of the mode value to be encoded.

15. The method according to claim 14, wherein the swapping is carried out after each first and second encoding process.

16. The method according to claim 1, wherein the second encoding process has at least first and second coding tables of different sizes, the first coding table being used when there is a first number of predetermined values and the second coding table being used when there is a second number of predetermined values different from the first number, and the second information being used as index information for both the first and second coding tables, and wherein a common index table is used to derive the index information for both the first and second tables from the mode value to be encoded.

17. The method according to claim 11, wherein the second encoding process comprises binarising the derived second information to generate bins and applying arithmetic coding to the bins.

18. The method according to claim 1, wherein in the first encoding process, when there are two or more predetermined values, the first information is dependent on an order of probability of occurrence of the predetermined values.

19. Apparatus for encoding a mode value representing a prediction mode, comprising:
a first encoding unit which carries out a first encoding process comprising encoding first information indicating a predetermined relationship between the mode value to be encoded and at least one predetermined value;
a second encoding unit which carries out a second encoding process comprising encoding second information representing the mode value to be encoded; and
a selecting unit which selects, from among at least the first and second encoding processes, an encoding process to apply to the mode value to be encoded;
wherein the second encoding unit takes account of the outcome of at least one prior first encoding process when carrying out the second encoding process.

20. A computer-readable storage medium storing a program which, when run on a computer or processor, causes the computer or processor to carry out a method of encoding a mode value representing a prediction mode, the program comprising:
a code portion which selects from among at least first and second encoding processes an encoding process to apply to the mode value to be encoded, the first encoding process comprising encoding first information indicating a predetermined relationship between the mode value to be encoded and at least one predetermined value, and the second encoding process comprising encoding second information representing the mode value to be encoded;
a code portion which makes the encoding by the second encoding process take account of the outcome of at least one prior first encoding process.
